(19) United States
(12) Patent Application Publication
(10) Pub. No.: US 2010/0108923 A1
(43) Pub. Date: May 6, 2010

(54) ELECTROPNEUMATIC TRANSDUCER WITH A PNEUMATIC PRESSURE-REGULATING VALVE

(75) Inventor: Herbert Moeller, Bad Oeynhausen (DE)

Correspondence Address: BUCHANAN, INGERSOLL & ROONEY PC, POST OFFICE BOX 1404, ALEXANDRIA, VA, 22313-1404, US

(73) Assignee: ABB Technology AG, Zuerich (CH)

(21) Appl. No.: 12/609,581

(22) Filed: Oct. 30, 2009

(30) Foreign Application Priority Data
Nov. 4, 2008 (DE) 10 2008 055 854.0

(51) Int. Cl. F16K 31/02

(52) U.S. Cl. 251/129.01

(57) ABSTRACT

An electropneumatic transducer is disclosed having a pneumatic pressure-regulating valve for regulating a control pressure in a pressure chamber by a regulator diaphragm, which rests on (e.g., against a counter-bearing). The counter-bearing can include at least one pressure disk, a regulator spring and an adjusting screw, the regulator diaphragm being held in force equilibrium by the regulator spring and the control pressure. The regulator diaphragm can be coupled to a control valve such that the control valve opens or closes as a function of actual control pressure. The counter-bearing can include an electrically drivable actuator.

### RELATED APPLICATION

This application claims priority under 35 U.S.C. §119 to German Patent Application No. 10 2008 055 854.0 filed in Germany on Nov. 4, 2008, the entire content of which is hereby incorporated by reference in its entirety.

### FIELD

The disclosure relates to an electropneumatic transducer with a pneumatic pressure-regulating valve for regulating a control pressure by, for example, a regulator diaphragm which is held in force equilibrium by a reference element and the control pressure.

### BACKGROUND INFORMATION

Pneumatic electropneumatic transducers are known which can convert an electrical signal into a pneumatic signal. The pressure of the control air can be changed by a nozzle/baffle plate system in accordance with an electrical signal. To this end, firstly the control air is adjusted to a constant pressure by a pressure regulator. This control air then flows through a nozzle against a baffle plate. By adjusting the distance between the baffle plate and the nozzle, the flow rate and thus also the control pressure (dynamic pressure) may be changed.

Pressure-regulating valves are known and are used to establish a constant regulating pressure irrespective of variations in the pressure of a pressure medium supplied.

WO 05088417 A1 discloses a pneumatic pressure-regulating valve whose throughput may be modified automatically as a function of pressure. An adjusting diaphragm is acted on by a reference pressure, by the gas pressure and by a regulator spring, whereby the operating diaphragm is adjusted on modification of the differential pressure and the diaphragm itself or a closing member actuated thereby modifies the throughput through an outflow cross-section. A structure adjoining the outflow cross-section on the diaphragm side forms a limit stop for the operating diaphragm or for the closing member in the closing position thereof. Provision is here made for at least one preliminary limit stop to be arranged in the pressure-regulating valve in such a way that, upon movement of the operating diaphragm in the closing direction, the operating diaphragm or the closing member firstly comes into contact with the preliminary limit stop and in that, on further movement of the operating diaphragm in the closing direction, the operating diaphragm or the closing member, with resiliently flexible deformation or with further resiliently flexible deformation, then further reduces throughput and in a final position also comes into contact with the limit stop.

DE 3305092 C2 discloses a pressure-regulating valve for pneumatic and hydraulic pressure media, which includes a housing with primary connection, secondary connection and relief connection and of an on-off valve arranged in the housing. The on-off valve includes a valve plunger bearing a valve disk and a valve seat fixed to the housing between primary connection and secondary connection. The on-off valve opens with the primary pressure. The valve plunger projects through the valve seat. The valve disk of the relief valve may be acted on by the force of a regulator magnet. A control connection provided with a control plunger is provided for feedback of a control variable. The control plunger is connected firmly with the valve disk of the relief valve via a push-rod. The push-rod extends through the hollow valve plunger of the on-off valve and through a bore in the valve disk of the on-off valve. The end remote from the on-off valve of the hollow valve plunger forms a valve seat for the valve disk of the relief valve.

DE 20 2004 003 860 U1 discloses a pneumatic pressure-regulating valve, which is arranged in the course of a gas line, whose throughput may be automatically modified by the pressure-regulating valve as a function of the differential pressure between one or more gas pressures applied to at least one input of the pressure-regulating valve. An operating diaphragm is provided in the pressure-regulating valve, which is acted on, on the one hand, by a reference pressure and, on the other hand, by the gas pressure or the gas pressures and by a regulator spring. By modifying the differential pressure between the areas adjoining the operating diaphragm, the operating diaphragm is adjusted and the operating diaphragm itself or a closing member actuated by the operating diaphragm increases or reduces throughput through an outflow cross-section of the pressure-regulating valve. In this case, a structure of the pressure-regulating valve adjoining the outflow cross-section on the diaphragm side forms a limit stop for the operating diaphragm or for the closing member actuated by the operating diaphragm in the closing position thereof. At least one preliminary limit stop is arranged in the pressure-regulating valve in such a way that, upon movement of the operating diaphragm in the closing direction, the operating diaphragm or the closing member actuated by the operating diaphragm firstly comes into contact with the preliminary limit stop. Upon further movement of the operating diaphragm in the closing direction, the operating diaphragm or the closing member actuated by the operating diaphragm then further reduces throughput with further resiliently flexible deformation and in a final position also comes into contact with the limit stop.

The resiliently flexible deformation of the closing member can result in the long term in lasting plastic deformation. This can influence the constancy of the regulating pressure, since even small changes in the pretensioning of the regulator spring can result in inadmissible deviations of the set regulating pressure. These inadmissible deviations can initially remain concealed and unrecognized as the cause of perceptible disturbances to downstream apparatus.

German patent application DE 10 2008 006 407 A1 discloses a pneumatic pressure-regulating valve for regulating a control pressure in a pressure chamber with a regulator diaphragm, which is held in force equilibrium by a regulator spring and control pressure. The regulator diaphragm is coupled to a control valve in such a way that the control valve opens or closes as a function of the actual control pressure. In this case, the control valve is formed by a dimensionally stable ball, which sits, loaded by a spring, in a conical bore, tapering in the direction of the regulator diaphragm, in a housing wall opposite the regulator diaphragm relative to the pressure chamber. The regulator diaphragm includes a reinforcement in the area of contact with the ball and the ball follows the movement of the regulator diaphragm in its normal direction.

Known electropneumatic transducers having a pressure regulator and a separate, electrically excited pressure control element, can entail considerable manufacturing effort and use a large amount of installation space.

### SUMMARY

An electropneumatic transducer is disclosed having a pneumatic pressure-regulating valve for regulating a control pressure in a pressure chamber, the pneumatic pressure-regulating valve comprising: a regulator diaphragm, which rests against a counter-bearing having at least one pressure disk, a regulator spring, an adjusting screw and an electrically drivable actuator, the regulator diaphragm being positioned to be held in force equilibrium by the regulator spring and a control pressure; and a control valve operatively coupled with the regulator diaphragm such that the control valve will open or close as a function of the control pressure.

### BRIEF DESCRIPTION OF THE DRAWINGS

Further details and advantages of the disclosure are explained in greater detail below with reference to a detailed description of exemplary embodiments and associated drawings wherein:

FIG. 1 shows a sectional representation of an exemplary electropneumatic transducer;

FIG. 2 is a schematic diagram of an exemplary electrical circuit of the electropneumatic transducer.

### DETAILED DESCRIPTION

An electropneumatic transducer is disclosed which can, for example, be compact with a simple structure and which can be manufactured with little effort and consume a relatively small installation space.

An exemplary pneumatic pressure-regulating valve as disclosed herein can regulate a control pressure in a pressure chamber by a regulator diaphragm, which rests on a counter-bearing, the counter-bearing having at least one pressure disk, a regulator spring and an adjusting screw. The regulator diaphragm can be held in force equilibrium by the regulator spring and the control pressure. The regulator diaphragm can be coupled to a control valve in such a way that the control valve opens or closes as a function of the actual control pressure. The control valve can be formed by a dimensionally stable ball, which sits spring-loaded in a conical bore, tapering in the direction of the regulator diaphragm, in a dimensionally stable housing wall opposite the regulator diaphragm relative to the pressure chamber and which follows the movement of the regulator diaphragm in its normal direction.

According to the disclosure, the counter-bearing can include an electrically drivable actuator. The pressure disk, the regulator spring and/or the mounting of the adjusting screw in an actuator can be configured in accordance with exemplary embodiments disclosed herein. The actuator can include at least one piezo element, which modifies at least one geometric dimension as a function of an applied electrical voltage.

The regulating pressure setpoint can be predetermined by a suitable electrical signal. As a function of the setpoint setting, the counter-bearing can adopt a position in relation to the control valve which corresponds to a desired control pressure in the pressure chamber.

For example, as the control pressure in the pressure chamber drops, the regulator spring presses the regulator diaphragm against the ball and pushes the latter out of its seat. The control valve is then opened and the supply of unregulated pressure medium is released. When the predetermined control pressure is reached, the regulator diaphragm is deflected towards the regulator spring. The force of the spring presses the ball into its seat and the control valve is closed. To change the control pressure, the voltage at the respective actuator of the counter-bearing is adjusted as a function of the setpoint setting.

An exemplary compact electropneumatic transducer with a simple structure as disclosed herein can be manufactured with little effort, and can consume relatively little installation space due, for example, to dynamization of known static elements.

An exemplary pressure sensor can be acted on by the actual control pressure, the electrical signal controlling the actuator of the counter-bearing being capable of being influenced as a function of the measured control pressure of the pressure sensor.

Inaccuracies in the piezoceramics of the actuator can be effectively eliminated thereby, as can be temperature influences and hysteresis effects.

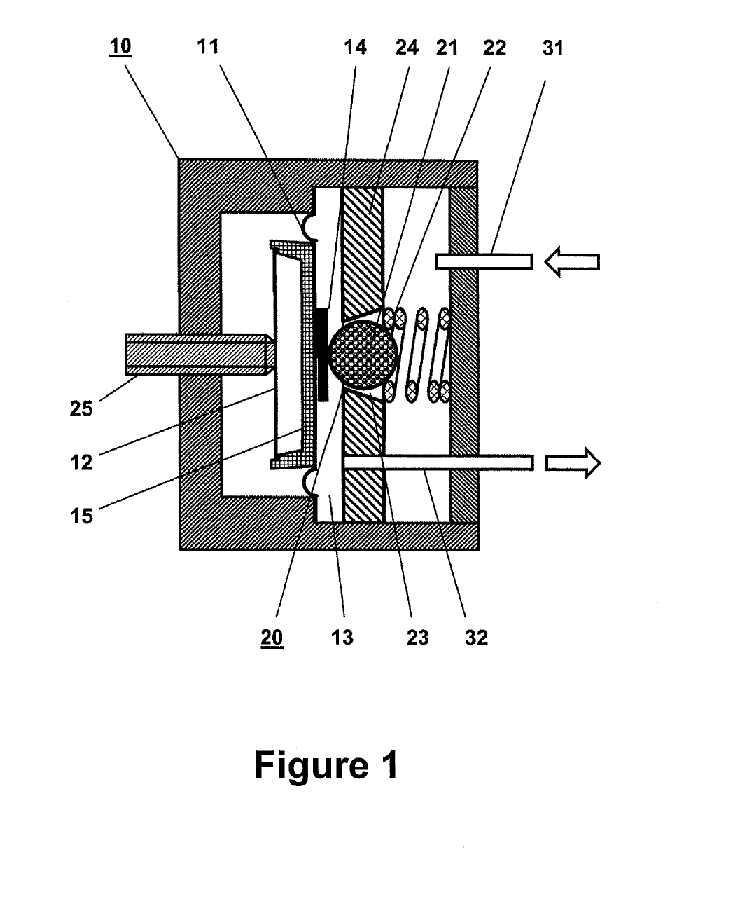

FIG. 1 is a sectional representation of an exemplary electropneumatic transducer 10 with a pneumatic pressure-regulating valve. The pressure-regulating valve includes a pressure chamber 13, which can be enclosed by a regulator diaphragm 11 and a housing wall 24 opposite thereto.

A control valve 20 is arranged in the housing wall 24, which valve can be formed by a dimensionally stable ball 21, which sits, loaded by a spring 22, in a conical bore 23 tapering towards the regulator diaphragm 11. The unregulated pressure medium 31 is supplied to the side of the ball 21 facing the spring 22.

The regulator diaphragm 11 can rest in a force-fitting manner on a pressure disk 15, which is connected to a rotationally symmetrical regulator spring 12. The regulator spring 12 rests at its center of gravity on an adjusting screw 25.

The pressure disk 15 can, for example, take the form of an axially acting actuator. In an exemplary embodiment, the regulator spring 12 can take the form of a bending actuator. Provision can be made for the pressure disk 15 to be connected indirectly and non-positively with the regulator diaphragm 11. In an exemplary embodiment, the adjusting screw 25 can take the form of an axially acting actuator. The actuator can, for example, include at least one piezo element, which is triggered electrically in accordance with the predetermined setpoint of the control pressure 32.

The diameter of the ball 21 is related to the conicity of the bore 23 in such a way that a segment of the ball 21 projects in the direction of the regulator diaphragm 11 into the pressure chamber 13. In this case, the ball 21 lies non-positively on the regulator diaphragm 11 and is directly actuated by the regulator diaphragm 11 as a function of the pressure in the pressure chamber 13.

The regulator diaphragm 11 is plastically reinforced in the area of the control valve 20. In a first exemplary embodiment, the regulator diaphragm 11 has a greater material thickness in the region of the control valve 20 than at its edge. In an alternative exemplary embodiment, the regulator diaphragm 11 is reinforced in the area of the control valve 20 by a fixed plate. In a particular configuration of the disclosure, this plate is formed by a metal plate 14. This embodiment can, for example, be used for soft regulator diaphragms 11 for regulating low control pressures 32.

The metal plate 14 can be arranged on the side of the regulator diaphragm 11 facing the pressure chamber 13. In this case, the ball 21 of the control valve 20 can rest on the metal plate 14 of the regulator diaphragm 11. In this way, damage to the regulator diaphragm 11 can be avoided and constancy can be achieved for the control pressure 32.

As the control pressure in the pressure chamber 13 drops, the regulator spring 12 presses the regulator diaphragm 11 against the ball 21 and pushes it out of its seat. The control valve 20 is then opened and the supply of unregulated pressure medium 31 is released. When the control pressure 32 is reached, the regulator diaphragm 11 is deflected towards the regulator spring 12. The force of the spring 22 presses the ball 21 into its seat and the control valve 20 is closed. The correct control pressure 32 may be preset with the adjusting screw 25.

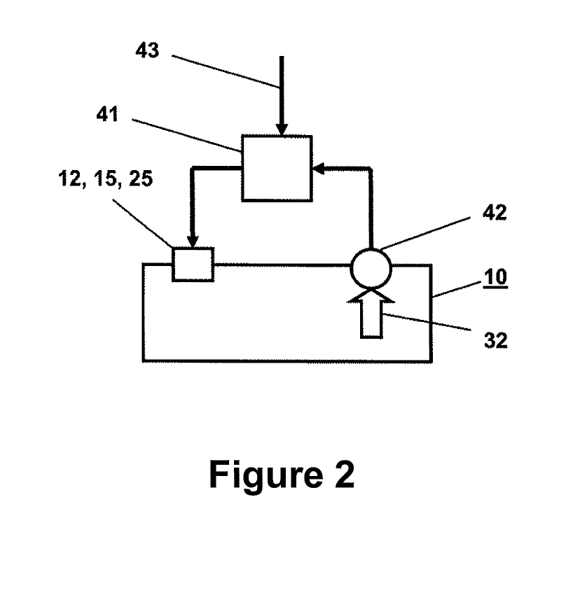

FIG. 2 is a schematic diagram of an exemplary electrical circuit of the electropneumatic transducer. The setpoint 43 fed electrically to the electropneumatic transducer 10 is processed in a signal processing means 41 and supplied to an electrically drivable actuator represented in FIG. 2 as an electric drive associated with the components 12, 15, 25. For example, the adjusting screw 25 can be mounted, at least partially, in the electrically drivable actuator, such as an electrically actuated piezo element, and driven in an axial direction relative to the regulator spring 12 and pressure disk 15.

The actual control pressure 32 is measured using a pressure sensor 42. The pressure sensor 42 produces a measure of control pressure as a signal, and is connected to the signal processing means 41. As a function of the measured control pressure 32, the electrical signal being used for controlling the final controlling elements 12, 15, 25, acting as an actuator, of the counter-bearing is influenced by means of the measured control pressure via the signal processing means 41.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE NUMERALS

10 Electropneumatic transducer
11 Regulator diaphragm
12 Regulator spring
13 Pressure chamber
14 Reinforcement
15 Pressure disk
20 Control valve
21 Ball
22 Spring
23 Bore
24 Housing wall
25 Adjusting screw
31 Unregulated pressure medium
32 Regulated control pressure
41 Signal processing means
42 Pressure sensor
43 Setpoint

What is claimed is:

1. An electropneumatic transducer having a pneumatic pressure-regulating valve for regulating a control pressure in a pressure chamber, the pneumatic pressure-regulating valve comprising:
a regulator diaphragm, which rests against a counter-bearing having at least one pressure disk, a regulator spring, an adjusting screw and an electrically drivable actuator, the regulator diaphragm being positioned to be held in force equilibrium by the regulator spring and a control pressure; and
a control valve operatively coupled with the regulator diaphragm such that the control valve will open or close as a function of the control pressure.

2. The electropneumatic transducer as claimed in claim 1, wherein the pressure disk is an axially acting actuator.

3. The electropneumatic transducer as claimed in claim 1, wherein the regulator spring is a bending actuator.

4. The electropneumatic transducer as claimed in claim 1, wherein the regulator spring rests against the adjusting screw, which is mounted to and driven by the electrically drivable actuator in an axial direction.

5. The electropneumatic transducer as claimed in claim 1, wherein the regulator spring is connected indirectly and non-positively via the pressure disk to the regulator diaphragm.

6. The electropneumatic transducer as claimed in claim 1, wherein the electrically drivable actuator comprises:
at least one piezo element.

7. The electropneumatic transducer as claimed in claim 1, comprising:
a pressure sensor which is acted on by the control pressure to produce a measure of control pressure which will influence an electrical signal controlling the electrically drivable actuator of the counter-bearing.

8. The electropneumatic transducer as claimed in claim 2, wherein the regulator spring is a bending actuator.

9. The electropneumatic transducer as claimed in claim 8, wherein the regulator spring rests against the adjusting screw, which is mounted to and driven by the electrically drivable actuator in an axial direction.

10. The electropneumatic transducer as claimed in claim 9, wherein the regulator spring is connected indirectly and non-positively via the pressure disk to the regulator diaphragm.

11. The electropneumatic transducer as claimed in claim 10, wherein the electrically drivable actuator comprises:
at least one piezo element.

12. The electropneumatic transducer as claimed in claim 11, comprising:
a pressure sensor which is acted on by the control pressure to produce a measure of control pressure which will influence an electrical signal controlling the electrically drivable actuator of the counter-bearing.
